(19) United States
(12) Patent Application Publication
(10) Pub. No.: US 2010/0162316 A1
(43) Pub. Date: Jun. 24, 2010

(54) DISPLAY APPARATUS AND CONTROL METHOD THEREOF

(75) Inventor: Sun-young KIM, Seoul (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 12/644,366

(22) Filed: Dec. 22, 2009

(30) Foreign Application Priority Data
Dec. 24, 2008 (KR) 10-2008-0133898

(51) Int. Cl. H04N 5/445; G06F 3/048; G06F 3/033

(52) U.S. Cl. 725/44; 715/764; 715/863

(57) ABSTRACT

The present invention relates to a display apparatus and a control method thereof. The display apparatus according to the present invention includes a display unit; a contents processing unit that processes contents; a user input unit that inputs control signals to retrieve the contents; a control unit that, if the control signals are continuously input, controls the contents processing unit to display minimum contents data on the display unit, retrieves contents corresponding to the control signals continuously input upon completion of inputting the control signals, and controls the contents processing unit to display the retrieved contents on the display unit. With this configuration, a display apparatus and a control method thereof, being capable of promptly reacting with a user's input and displaying contents, are provided.

### CROSS-REFERENCE TO RELATED APPLICATIONS

This application claims priority from Korean Patent Application No. 10-2008-0133898, filed on Dec. 24, 2008, in the Korean Intellectual Property Office, the disclosure of which is incorporated by reference in its entirety.

### BACKGROUND OF THE INVENTION

1. Field of the Invention

Apparatuses and methods consistent with the present invention relate to display apparatuses and control methods thereof, and more particularly, to a display apparatus and a control method thereof, displaying contents in reaction with a user's input.

2. Description of the Related Art

In the related art, televisions have displayed only broadcasting signals corresponding to video signals. Different from the related art televisions, up-to-date televisions are capable of displaying diverse data information or a variety of contents received from a server. As the display apparatuses become capable of implementing diverse features, user interfaces to control contents have also developed gradually. For example, graphic user interfaces have become diverse, and interfaces using tactual sense or auditory sense, in addition to visual interfaces, are also on the increase.

A user can continuously generate various selection signals to control contents through a user interface. In this case, the display apparatus requires prompt and accurate response with the user's selection, to thereby display and control the contents as desired by the user.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

Accordingly, an aspect of the present invention is to provide a display apparatus and a control method thereof, capable of promptly reacting with a user's input and displaying contents.

Another aspect of the present invention is to provide a display apparatus and a control method thereof, being capable of displaying a final content as desired by a user in reaction with the user's continuous inputs.

According to an aspect of the present invention, there is provided a display apparatus having a display unit, including: a contents processing unit that processes contents; a user input unit that receives user input to generate control signals to retrieve the contents; a control unit that, if the control signals are continuously generated, controls the contents processing unit to display minimum contents data on the display unit, retrieves contents corresponding to the control signals continuously input upon completion of the user input, and controls the contents processing unit to display the retrieved contents on the display unit.

The control processing unit may include a storage unit that stores the minimum contents data therein.

An amount of contents retrieved in response to a single control signal mat be preset, and the control unit may count a number of the input control signals, retrieves the contents corresponding to the counted number of the input control signals, and may display the retrieved contents corresponding to the counted number of the input control signal on the display unit.

The user input unit may comprise a touch panel disposed in the display unit, generating the control signals, an amount of contents retrieved corresponding to a unit touch duration of a single touch applied to the touch panel may be preset, and the control unit which counts a number of touches time applied to the touch panel, retrieves the contents corresponding to the counted number of touches, and displays a content corresponding to the counted number of touches on the display unit.

The display apparatus may further include a broadcast receiving unit that receives broadcasting signals, wherein the contents include EPG information.

The minimum contents data may include a frame to indicate broadcasting programs and broadcasting times of the broadcasting programs.

The display apparatus may further include a communication unit that receives contents from an external server, wherein the contents include stock data supplied from the external server.

The minimum contents data may include a frame to display the stock data.

The contents may include geographical data including a map.

According to another aspect of the present invention, there is provided a control method of a display apparatus, including receiving input control signals to retrieve contents; displaying minimum contents data if the input control signals are continuously input; and displaying contents corresponding to the continuously input control signals upon complete reception of the control signals.

The amount of contents retrieved in reaction with a single control signal may be preset, and the displaying of the contents may include counting a number of the input control signals; retrieving the contents corresponding to the counted number of input control signals; and displaying a content corresponding to the counted number of input control signals.

The display apparatus may include a touch panel to generate the control signals, an amount of contents retrieved response to a unit touch duration of a single touch applied to the touch panel may be preset, and the displaying of the contents may include counting a number of touches applied to the touch panel; retrieving the contents corresponding to the counted number of touches; and displaying a content corresponding to the counted number of touches.

The display apparatus may further include a broadcasting receiving unit that receives broadcasting signals, and the contents may include EPG information.

The minimum contents data may include a frame to display the broadcasting programs and the broadcasting times of the broadcasting programs.

The display apparatus may further include a communication unit that receives contents from an external server, and the contents may include stock data supplied from the external server.

The minimum contents data may include a frame to display the stock data.

The contents may include geographical data including a map.

The single control signal may includes selecting an input button once or touching the touch panel once.

According to another aspect of the present invention, there is provided a method of retrieving contents data including inputting a control signal to retrieve the contents data; determining an amount of the contents data to be retrieved in response to a number of times that the control signal is input, and displaying the contents in accordance with the number of times that the control signal is input.

If the control signal is input once, the contents data is displayed in a first predetermined manner, and if the control signal is continuously input, the contents data is displayed in a second predetermined manner, and the first predetermined manner comprises displaying the contents data relating to program information, and the second predetermined manner comprises displaying minimum contents until a final control signal is input and then displaying the contents data relating to the program information after the final control signal is input.

The control signals may be determined to be continuously input if the control signals are repeatedly input during a specified time.

### BRIEF DESCRIPTION OF THE DRAWINGS

The above embodiments and/or utilities of the present invention will become apparent and more readily appreciated from the following description of the exemplary embodiments, taken in conjunction with the accompanying drawings of which:

FIG. 1 is a control block diagram of a display apparatus according to an exemplary embodiment of the present invention;

FIGS. 2A to 2C illustrate contents displaying methods of the display apparatus of FIG. 1;

FIG. 3 is a control block diagram of a display apparatus according to another exemplary embodiment of the present invention;

FIG. 4A illustrates a contents displaying method of the display apparatus of FIG. 3;

FIG. 4B illustrates another contents displaying method of the display apparatus of FIG. 3; and

FIG. 5 is a flow chart to explain a control method of the display apparatus of claim 3.

### DETAILED DESCRIPTION OF THE EXEMPLARY EMBODIMENTS

Reference will now be made in detail to the exemplary embodiments according to the present invention, examples of which are illustrated in the accompanying drawings, wherein like reference numerals refer to the like elements throughout. The present invention can be modified to several different forms, which is not limited to the embodiments set forth herein. The embodiments are described below in order to explain the present invention by referring to the figures.

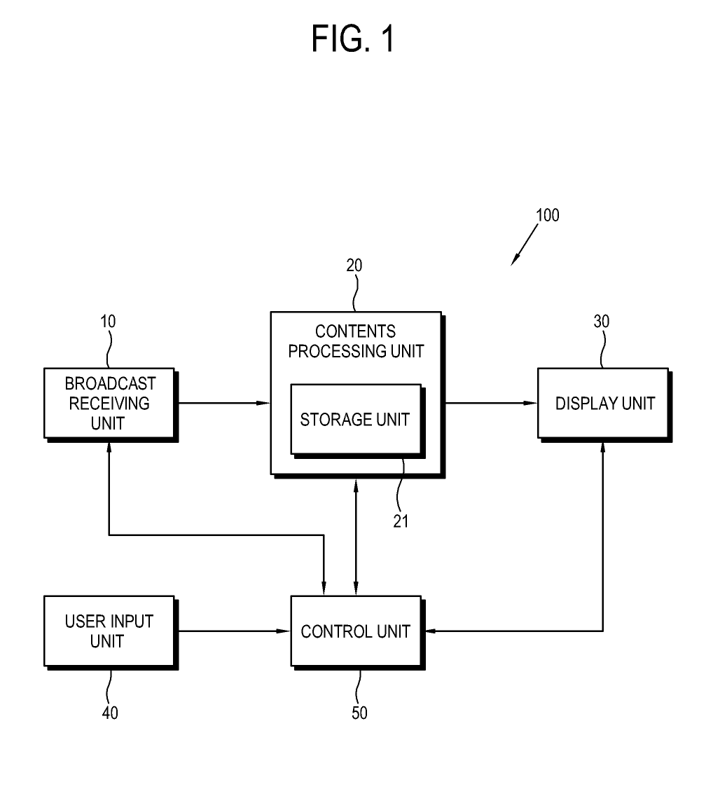

FIG. 1 is a control block diagram of a display apparatus 1 according to an exemplary embodiment of the present invention.

As shown in FIG. 1, the display apparatus 100 includes a broadcast receiving unit 10, a contents processing unit 20, a display unit 30, a user input unit 40, and a control unit 50 controlling them. The display apparatus 100 may be implemented by a television that processes and displays broadcasting signals or by a monitor connected to a computer main body.

The broadcast receiving unit 10 includes an antenna receiving and demodulating the broadcasting signals, a tuner or the like. Broadcasting signals received by the broadcast receiving unit 10, that is, contents, include video signals and data signals such as electronic program guide (EPG) information.

The contents processing unit 20 processes contents received through the broadcast receiving unit 10, and displays them on the display unit 30. The contents processing unit 20 may include signal processing blocks such as codec, a scaler, etc. Also, the contents processing unit 20 extracts minimum contents data from the received contents according to control by the control unit 50, stores them in a storage unit 21 and displays them on the display unit 30. The minimum contents data refers to the fewest contents displayed on the display unit 30 when a user continuously inputs control signals to retrieve contents. The minimum contents data will be described later in detail.

As described above, the minimum contents data are stored in the storage unit 21. The minimum contents data may be stored in the storage unit 21 by the control unit 50 in real time or may be updated at specific cycles once they are stored. The storage unit 21 may be included in the control unit 50 rather than in the contents processing unit 20, or may be provided as a separate memory.

The display unit 30 displays the contents processed by the contents processing unit 20 and minimum contents data associated with them. The display unit 30 may include a liquid crystal display (LCD) panel having liquid crystals, an organic light emitting diode (OLED) panel having organic light emitting devices or a plasma display panel (PDD), and a panel driving unit driving the panel.

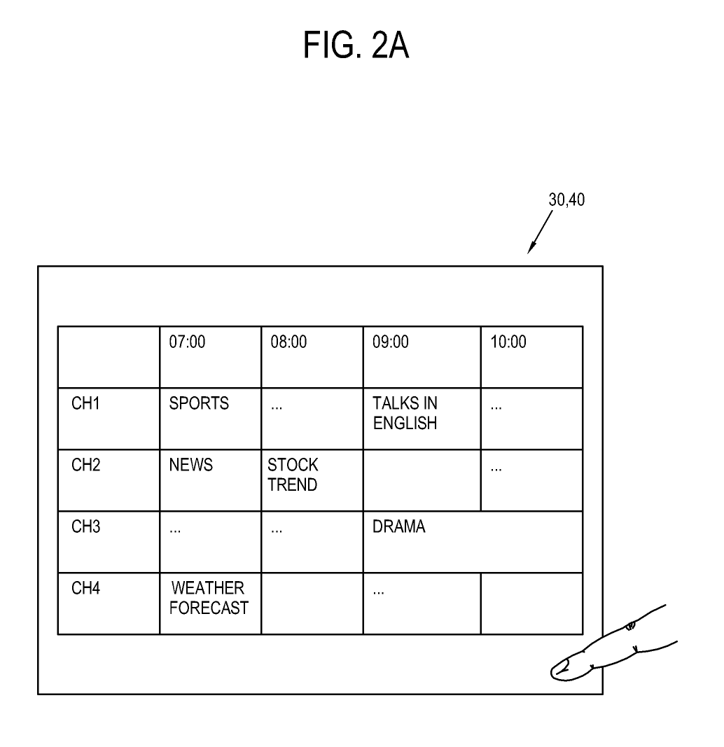

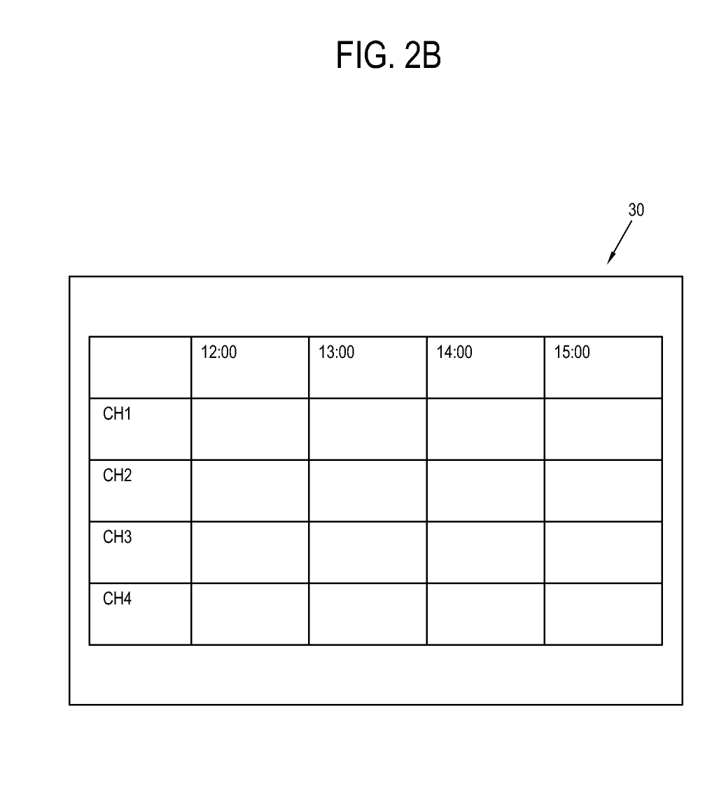

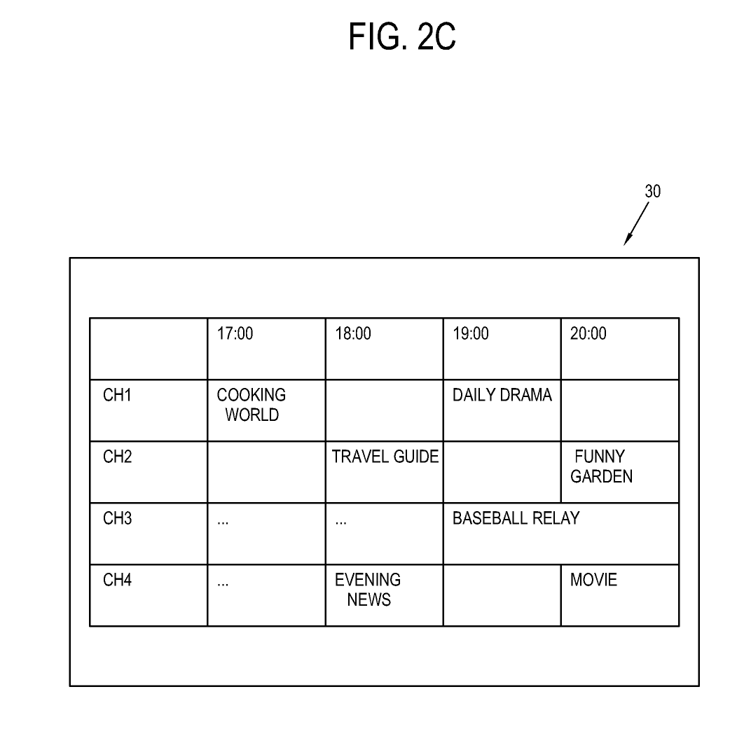

According to the user's manipulation, the user input unit 40 generates control signals for retrieving contents and outputs them to the control unit 50. The user input unit 40 according to this exemplary embodiment may be provided as a touch panel combined with the display unit 30, as shown in FIG. 2A. The touch panel may be arranged on the upper part of the display unit or internally built in the display unit 30. The user may execute diverse operations to input user input to generate control signals using his/her finger(s) or a pointing device on the display unit 30.

When the user touches the touch panel once, inputs touch signals of unit touch duration or moves a touch of the touch panel across the touched area in any specific direction by using his/her finger(s) or dragging the pointing device, the controls performed with respect to the generated control signals are predetermined. Hereinafter, a user touching a touch panel to generate a control signal is referred to as a user inputting a control signal, or control signals to retrieve contents, for brevity. Accordingly, when the user inputs a control signal once to retrieve contents (a “one-time control signal” or a “single control signal”), the amount of contents retrieved in response to the one-time control signal is predetermined. In other words, the amount of contents to be moved or displayed in response to the one-time control signal is predetermined.

The control unit 50 retrieves contents according to control signals input through the user input unit 40, and controls the contents processing unit 20 to display the retrieved contents on the display unit 30. If the control signals to retrieve contents are continuously input, the control unit 50 controls the control processing unit 20 to display minimum contents data on the display unit 30. FIGS. 2A to 2C illustrate contents displaying methods of the display apparatus of FIG. 2. The contents according to this exemplary embodiment refer to EPG information as shown in FIG. 2A. FIG. 2A shows that control signals are input by the user using his/her finger. As described above in detail, a control performed in response to a one-time control signal is predetermined, and the amount of contents retrieved in response to a control signal is also predetermined even in case of retrieving the EPG information. For example, FIG. 2A shows that program information for three hours from 07:00 to 10:00 is displayed. That is, if a control signal is input once, the program information is moved or displayed for a predetermined time, for example, per one hour, or the program information for 11:00 to 14:00 corresponding to the next three hours may be displayed.

If the user continuously inputs control signals, the control unit 50 determines that the user's inputs are continuous and displays the minimum contents data on the display unit 30 as shown in FIG. 2B. When the contents refer to EPG information, the minimum contents data may include broadcasting programs and a frame to indicate the broadcasting times of the broadcasting programs. The minimum contents data may also further include the name(s) and/or the number(s) with respect to the channel(s) constantly displayed. When control signals are continuously input, the display apparatus 100 according to this exemplary embodiment displays minimum contents data on the display unit 30, to thereby let the user know that contents are being retrieved. This decreases a load resulting from processing the contents. Thereafter, when inputting of the control signals is completed, the display apparatus 100 retrieves the contents corresponding to the continuously input control signals, and displays the retrieved contents as shown in FIG. 2C. In other words, the display apparatus 100 retrieves the contents corresponding to the touch signals continuously input, that is, by an amount in proportion to the unit touch duration, or the number of touches or the dragging distance of the touches, and displays a content corresponding to the final touch duration, the number of touches or the dragging distance of touches on the display unit 30.

In a related art case, if the user generates continuous inputs, contents are retrieved and displayed per each control signal, or the continuous control signals are disregarded and only the content corresponding to the first control signal is retrieved. In the former case, a great amount of time is consumed in retrieving the contents, and any other contents undesired by the user are also displayed, thereby failing to positively respond to the user's input(s). In the latter case, normal contents retrieval cannot be performed.

The minimum contents data extracted from the broadcasting signals is stored in the storage unit 21. When the user additionally generates continuous control signals, the control unit 50 controls the contents processing unit 20 to display the minimum contents data on the display unit 30. The control unit 50 may include a control signal receiving unit (not shown) to receive control signals input through the user input unit 40.

As an example of contents retrieval, this exemplary embodiment retrieves broadcasting programs using EPG information. However, this example does not serve to limit the applicable scope of the invention. For example, items of contents such as movie or music available in the display apparatus 100 are retrieved; similarly, the exemplary embodiments of the present invention are applicable to all of the contents available for continuous retrieval through the user input unit 40.

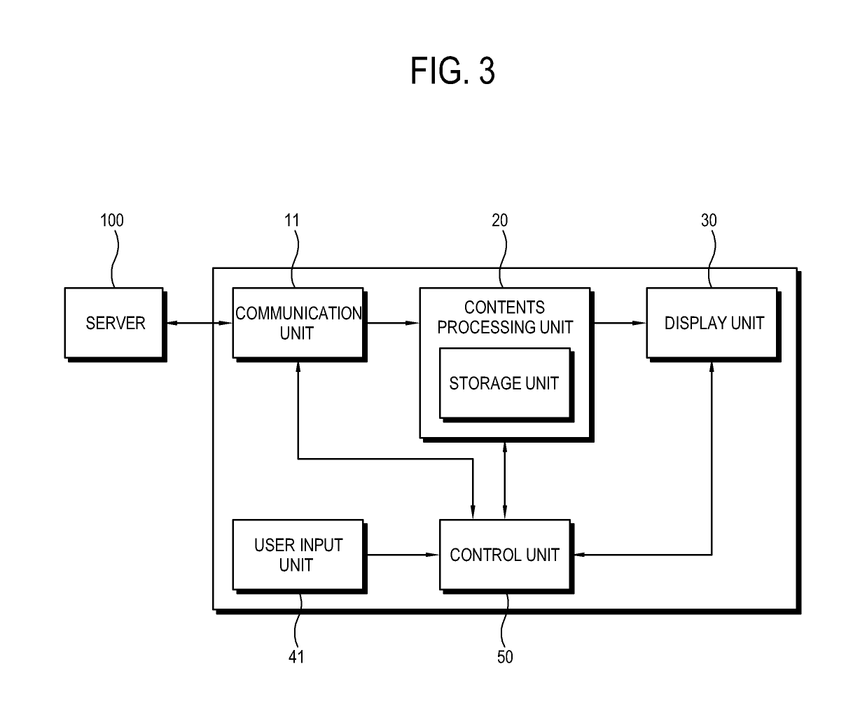

FIG. 3 is a control block diagram of a display apparatus according to another exemplary embodiment of the present invention.

As shown in FIG. 3, the display apparatus of this exemplary embodiment includes a communication unit 11, to communicate with the server 100 therethrough. The communication unit 11 receives a variety of contents transmitted from the server 100, and the transmitted contents are processed by the contents processing unit 20. The display apparatus according to this exemplary embodiment may be implemented by an internet protocol television (IPTV) connected to the server 100 using an internet protocol.

The user input unit 41 may include a button or a shortcut key with which to retrieve contents. In addition, the user input unit 41 may also be provided as an input device such as a keyboard or a mouse connected to a computer system, or a remote control device to control the display apparatus remotely. In this case, selecting the button or clicking the mouse one time is regarded as inputting a one-time control signal.

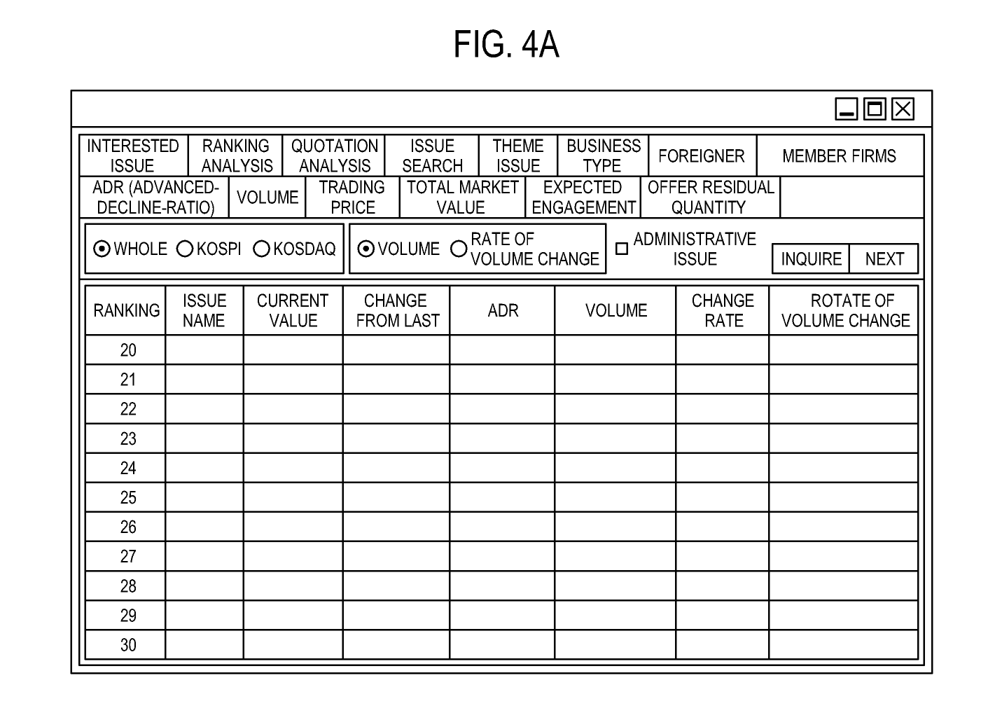

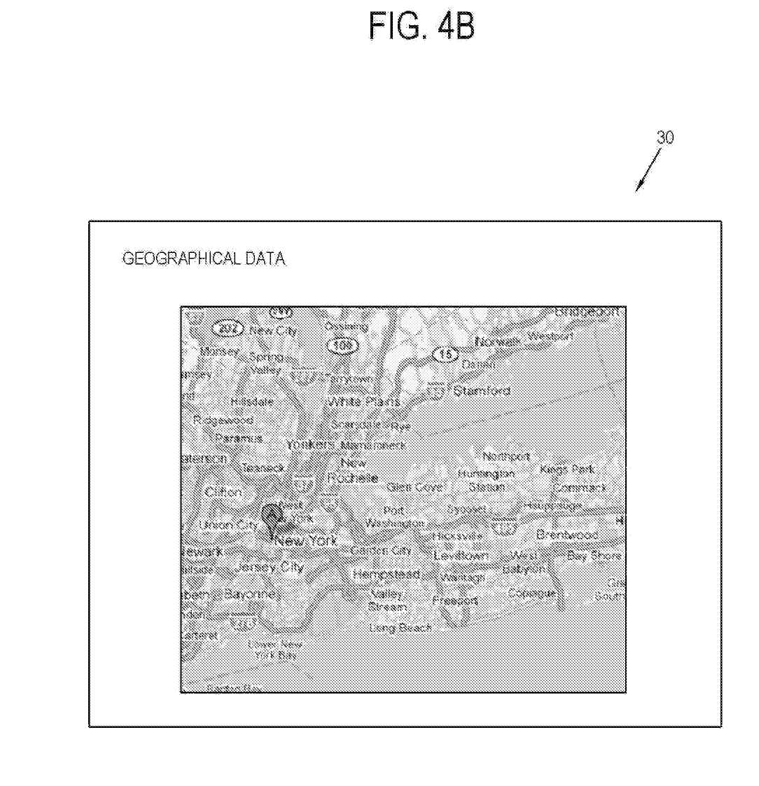

FIGS. 4A and 4B illustrate minimum contents data with respect to contents received from the server 100. Where the contents are stock data, the minimum contents data may include a frame to indicate the stock data as shown in FIG. 4A. If the user presses the button or clicks the mouse continuously in order to retrieve a desired stock item, i.e., company name, the contents processing unit 20 only displays a frame and brief item names to rapidly retrieve and display, among those contents transmitted from the server 100. Thereafter, when inputs of the control signals are completed, a content corresponding to the final control signal, is displayed. For example, the stock item name and its stock price are displayed. The control unit 50 counts the number of input control signals, in order to retrieve a content corresponding to the total number of control signals, i.e., the final control signal, and obtains the amount of contents corresponding to the counted control signals. That is, the control unit 50 retrieves the contents considering the number of the control signals received and displays a content corresponding to the final control signal.

FIG. 4B shows minimum contents data displayed when a user receives geographical data including a map and retrieves the map. Universally in retrieving a map, the user may magnify or reduce the map, or may move the map in all directions. In this case, if the control signals are continuously input, the minimum contents data may include brief text data such as major geographical names and a magnified map, or may be implemented by the map immediately before the continuous control signals are input. If the input of the control signals is completed, a map retrieved in response to the continuously input control signals is displayed. Besides, the present exemplary embodiment may be applicable even when retrieving route maps of transportation systems such as subway or bus, and the minimum contents data may include major stations or stops, or subway junctions.

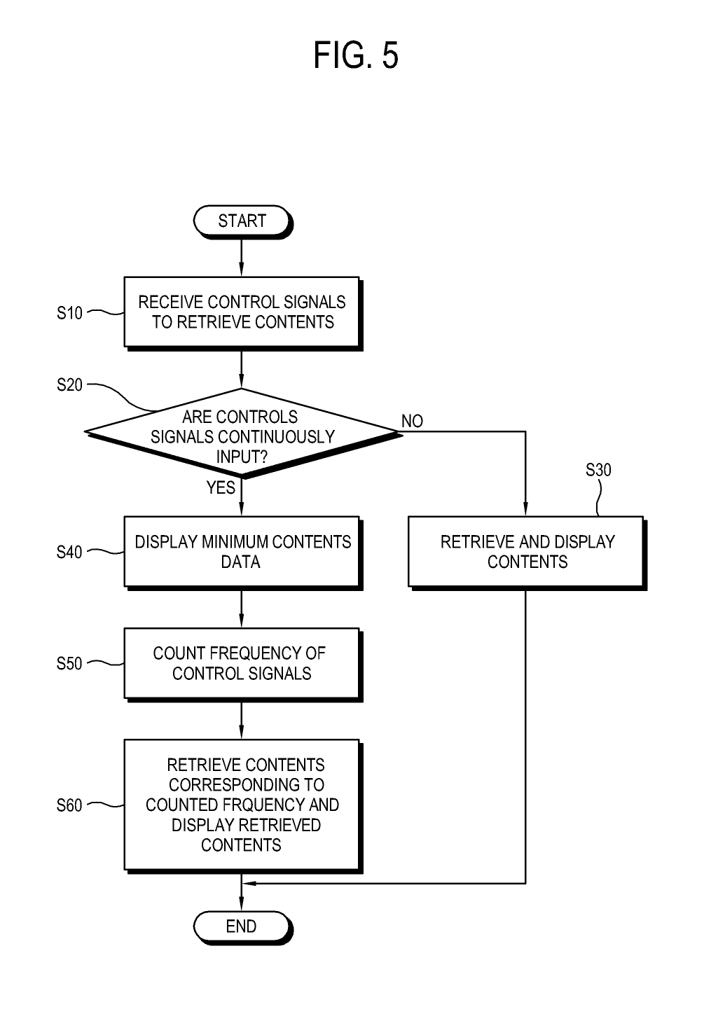

FIG. 5 is a control block diagram to explain a control method of the display apparatus of FIG. 3. The control method of the display apparatus according to this exemplary embodiment will be described with reference to FIG. 5.

The display apparatus first receives control signals to retrieve contents from a user (operation S10).

The control unit 50 determines whether control signals are continuously input (operation S20). When control signals are repeatedly input during a specific time, the control unit 50 may determine that the control signals are continuously input.

If the control signals are not continuously input, the control unit 50 retrieves contents by the amount of contents retrieved corresponding to a one-time control signal and displays them on the display unit (operation S30).

However, where the control signals are continuously input, the control unit 50 controls the contents processing unit to display minimum contents data on the display unit 30 (operation S40) and counts the control signals (operation S50).

After then, the contents accumulated are retrieved in correspondence with the counted number of control signals, and a content corresponding to the counted number of control signals received is displayed (operation S60).

Although a few exemplary embodiments of the present invention have been illustrated and described in details, the present invention shall be limited thereto, and can be carried out in a various manner, within the scope of the claims as claimed in the specification. Further, it will be appreciated by those skilled in the art that changes may be made in these exemplary embodiments without departing from the principles and spirit of the invention, the scope of which is defined in the appended claims and their equivalents.

1. A display apparatus having a display unit, comprising:
a contents processing unit that processes contents;
a user input unit that receives user input to generate control signals to retrieve the contents;
a control unit that, if the control signals are continuously generated, controls the contents processing unit to display minimum contents data on the display unit, retrieves contents corresponding to the continuously input control signals upon completion of the user input, and controls the contents processing unit to display the retrieved contents on the display unit.

2. The display apparatus of claim 1, wherein the control processing unit comprises a storage unit that stores the minimum contents data.

3. The display apparatus of claim 1, wherein an amount of contents retrieved in response to a single control signal is preset, and
the control unit counts a number of the input control signals, retrieves the contents corresponding to the counted number of the input control signals, and displays the retrieved contents corresponding to the counted number of the input control signal on the display unit.

4. The display apparatus of claim 1, wherein the user input unit comprises a touch panel disposed in the display unit, which generates the control signals,
an amount of contents retrieved corresponding to a unit touch duration of a single touch applied to the touch panel is preset, and
the control unit which counts a number of touches applied to the touch panel, retrieves the contents corresponding to the counted number of touches, and displays a content corresponding to the counted number of touches on the display unit.

5. The display apparatus of claim 1, further comprising a broadcast receiving unit that receives broadcasting signals, wherein the contents comprise Electronic Program Guide (EPG) information.

6. The display apparatus of claim 5, wherein the minimum contents data comprises a frame to indicate broadcasting programs and broadcasting times of the broadcasting programs.

7. The display apparatus of claim 1, further comprising a communication unit that receives the contents from an external server,
wherein the contents comprise stock data supplied from the external server.

8. The display apparatus of claim 7, wherein the minimum contents data comprises a frame to display the stock data.

9. The display apparatus of claim 1, wherein the contents comprise geographical data including a map.

10. A control method of a display apparatus, comprising:
receiving input control signals to retrieve contents;
displaying minimum contents data if the input control signals are continuously input; and
displaying contents corresponding to the continuously input control signals upon completion of receiving the continuously input control signals.

11. The control method of claim 10, wherein an amount of contents retrieved in response to a single control signal is preset,
the displaying of the contents comprises:
counting a number of the input control signals;
retrieving the contents corresponding to the counted number of input control signals; and
displaying a content corresponding to the counted number of input control signals.

12. The control method of claim 10, wherein the display apparatus comprises a touch panel to generate the input control signals,
an amount of contents retrieved in response to a unit touch duration of a single touch applied to the touch panel is preset,
the displaying of the contents comprises:
counting a number of touches applied to the touch panel;
retrieving the contents corresponding to the counted number of touches; and
displaying a content corresponding to the counted number of touches.

13. The control method of claim 10, wherein the display apparatus further comprises a broadcasting receiving unit that receives broadcasting signals, and
the contents comprise Electronic Program Guide (EPG) information.

14. The control method of claim 13, wherein the minimum contents data comprises a frame to display the broadcasting programs and the broadcasting times of the broadcasting programs.

15. The control method of claim 10, wherein the display apparatus further comprises a communication unit that receives the contents from an external server, and
the contents comprise stock data supplied from the external server.

16. The control method of claim 15, wherein the minimum contents data comprises a frame to display the stock data.

17. The control method of claim 10, wherein the contents comprise geographical data including a map.

18. The control method of claim 11, wherein the single control signal comprises selecting an input button once or touching the touch panel once.

19. A method of retrieving contents data comprising:
inputting a control signal to retrieve the contents data;
determining an amount of the contents data to be retrieved in response to a number of times that the control signal is input, and
displaying the contents in accordance with the number of times that the control signal is input.

20. The method of claim 19, wherein if the control signal is input once, the contents data is displayed in a first predetermined manner, and
if the control signal is continuously input, the contents data is displayed in a second predetermined manner, wherein the first predetermined manner comprises displaying the contents data relating to program information, and the second predetermined manner comprises displaying minimum contents until a final control signal is input and then displaying the contents data relating to the program information after the final control signal is input.

21. The method of claim 20, wherein the control signals are determined to be continuously input if the control signals are repeatedly input during a specified time.
